(19) United States
(12) Patent Application Publication
(10) Pub. No.: US 2026/0259640 A1
(43) Pub. Date: Sep. 3, 2026

(54) PERSONALIZED SINGLE-ACTION DISAMBIGUATION

(71) Applicant: Apple Inc., Cupertino, CA (US)

(72) Inventors: Ariana Isabel K. SOKOLOV, Coronado, CA (US); Thomas J. MOORE, Northglenn, CO (US); Rajandeep SINGH, San Francisco, CA (US)

(21) Appl. No.: 19/544,784

(22) Filed: Feb. 19, 2026

Related U.S. Application Data
(60) Provisional application No. 63/765,397, filed on Feb. 28, 2025.

(51) Int. Cl. G06F 3/0482; G06F 3/0488; G06F 16/2457; G06F 3/01; G06F 3/04815

(52) U.S. Cl. CPC G06F 3/0482; G06F 3/0488; G06F 16/2457; G06F 3/017; G06F 3/04815

(57) ABSTRACT

Disclosed herein are example processes for performing tasks based on user-selected objects. In an example method, a user input indicating selection of an object is detected and in response to the user input a first output is provided when an action for the selected object meets a confidence criterion and a second output is provided when the action for the selected object does not meet the confidence criterion.

### CROSS-REFERENCE TO RELATED APPLICATIONS

This application claims priority to U.S. Provisional Patent Application No. 63/765,397, entitled “USER INTERFACES FOR SHARING CONTEXTUALLY RELEVANT MEDIA CONTENT,” filed on February 28, 2025, the contents of which is hereby incorporated by reference in its entirety.

### TECHNICAL FIELD

The present disclosure generally relates to providing a response to an action selecting an object.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more image sensors: detecting a user input indicating selection of an object; in response to detecting the user input indication selection of the object: in accordance with a determination that an action for the selected object meets a confidence criterion, providing a first output based on the selected object and the action for the selected object; and in accordance with a determination that the action for the selected object does not meet the confidence criterion, providing a second output including a request for an action to be performed.

Example non-transitory computer-readable storage media are disclosed herein. An example non-transitory computer-readable storage medium stores one or more programs. The one or more programs are configured to be executed by one or more processors of a computer system that is in communication with one or more image sensors. The one or more programs include instructions for: detecting a user input indicating selection of an object; in response to detecting the user input indication selection of the object: in accordance with a determination that an action for the selected object meets a confidence criterion, providing a first output based on the selected object and the action for the selected object; and in accordance with a determination that the action for the selected object does not meet the confidence criterion, providing a second output including a request for an action to be performed.

Example computer systems are disclosed herein. An example computer system is configured to communicate with one or more image sensors. The computer system comprises: one or more processors; and memory storing one or more programs configured to be executed by the one or more processors, the one or more programs including instructions for: detecting a user input indicating selection of an object; in response to detecting the user input indication selection of the object: in accordance with a determination that an action for the selected object meets a confidence criterion, providing a first output based on the selected object and the action for the selected object; and in accordance with a determination that the action for the selected object does not meet the confidence criterion, providing a second output including a request for an action to be performed.

An example computer system is configured to communicate with one or more image sensors. The computer system comprises: means for detecting a user input indicating selection of an object; means, in response to detecting the user input indication selection of the object, for: in accordance with a determination that an action for the selected object meets a confidence criterion, providing a first output based on the selected object and the action for the selected object; and in accordance with a determination that the action for the selected object does not meet the confidence criterion, providing a second output including a request for an action to be performed.

Providing a first output based on the selected object and the action for the selected object when an action for the selected object meets a confidence criterion and providing a second output including a request for an action to be performed when the action for the selected object does not meet the confidence criterion allows the computer system to perform actions automatically and efficiently while also requesting actions in other circumstances. Specifically, this allows the computer system to provide responses more quickly when possible while still allowing the user to specify actions in other circumstances. In this manner, the user-device interaction is made more efficient and accurate (e.g., by reducing the number of inputs required to perform an action and by allowing the user to specify actions), which in turn reduces power usage and improves battery life of the device by enabling the user to use the device more quickly and efficiently.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user’s eyes and hand in space or the user’s body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIGS. 5A-5G illustrate a device performing tasks based on user-selected objects that are present in a three-dimensional scene, according to some examples.

FIG. 6 is a flow diagram of a method for performing tasks based on user-selected objects that are present in a three-dimensional scene, according to some examples.

### DETAILED DESCRIPTION

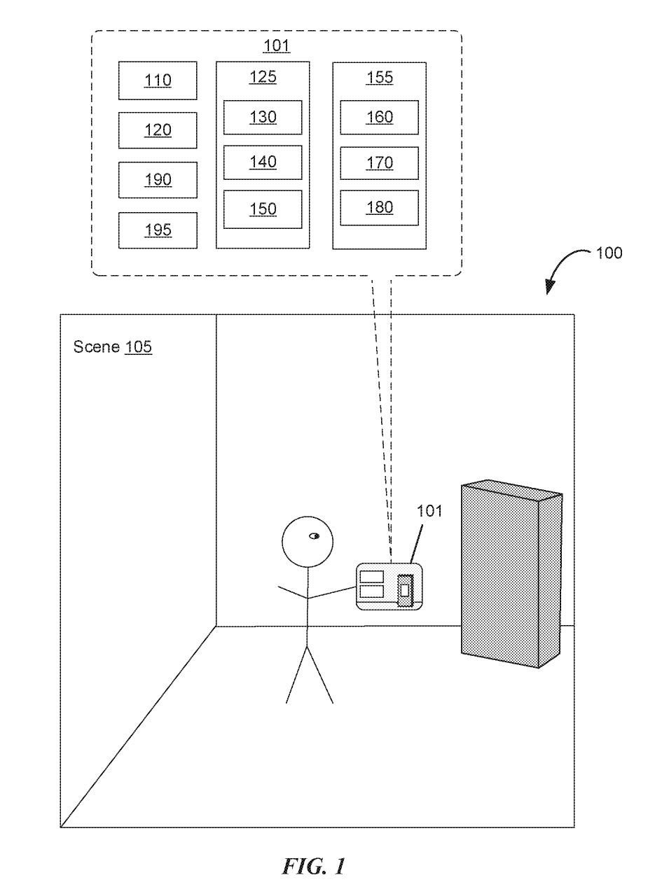

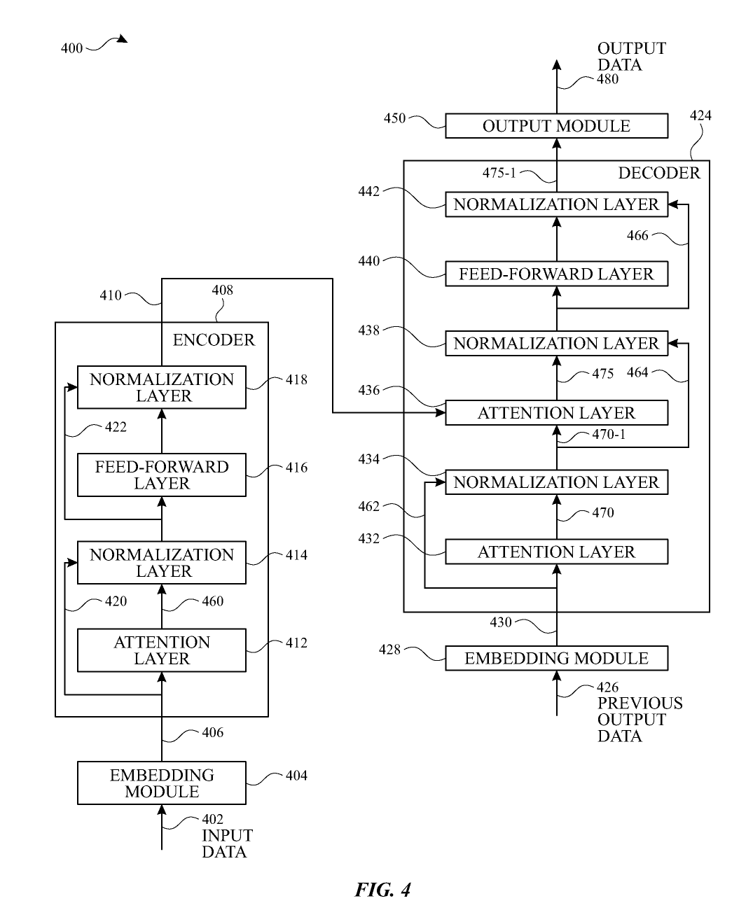

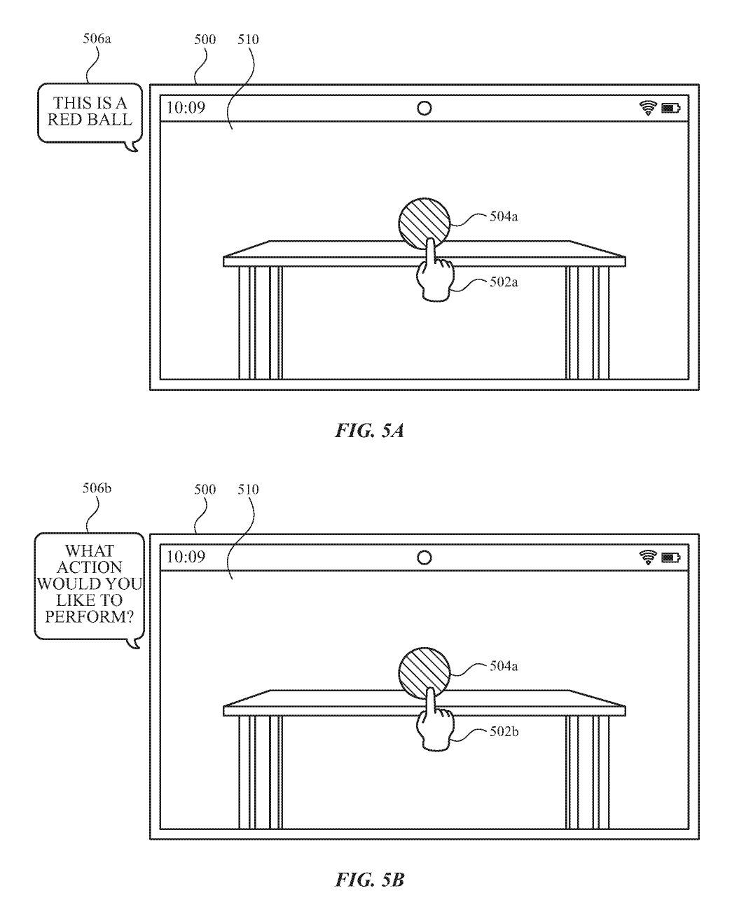

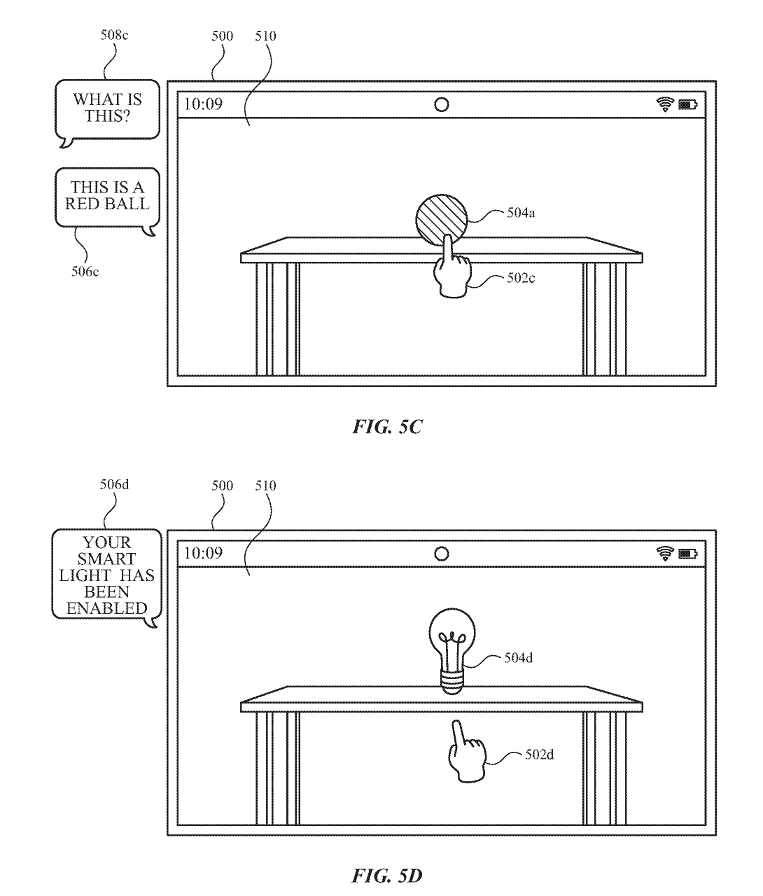

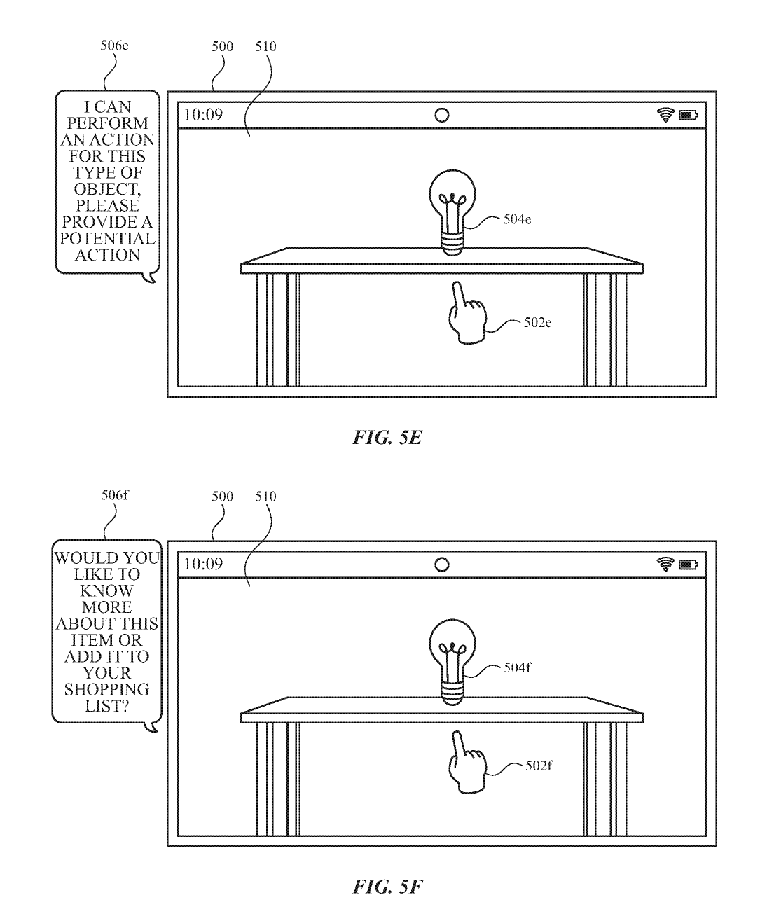

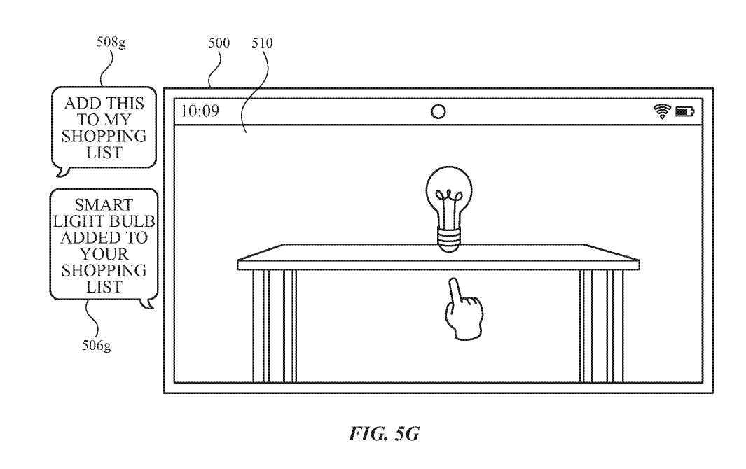

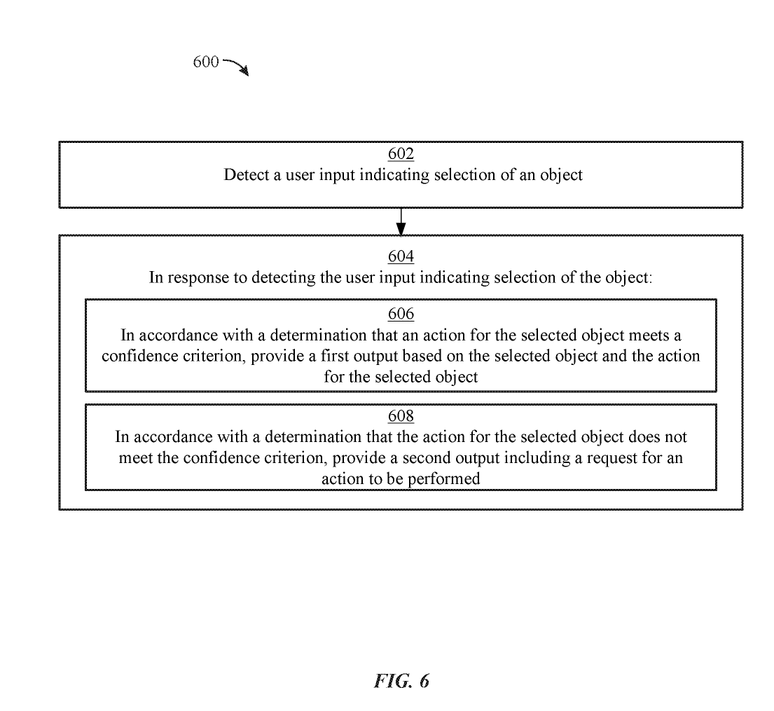

FIGS. 1-4 provide a description of example computer systems and techniques for interacting with three-dimensional scenes. FIGS. 5A-5G illustrate a device performing tasks based on user-selected objects that are present in a three-dimensional scene. FIG. 6 is a flow diagram of a method for performing tasks based on user-selected objects that are present in a three-dimensional scene. FIGS. 5A-5G are used to describe the method of FIG. 6.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

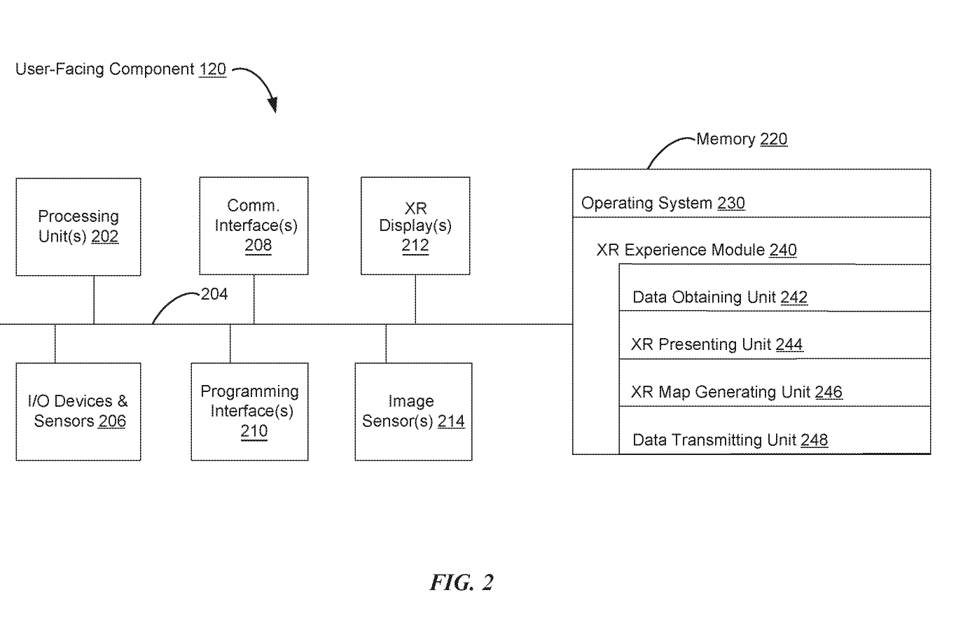

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user’s body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user’s body (e.g., the user’s eye(s), head, or hand)) could similarly be implemented with an HMD where the movement is caused by movement of the HMD relative to the physical environment (e.g., scene 105 or a part of the user’s body (e.g., the user’s eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user’s hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

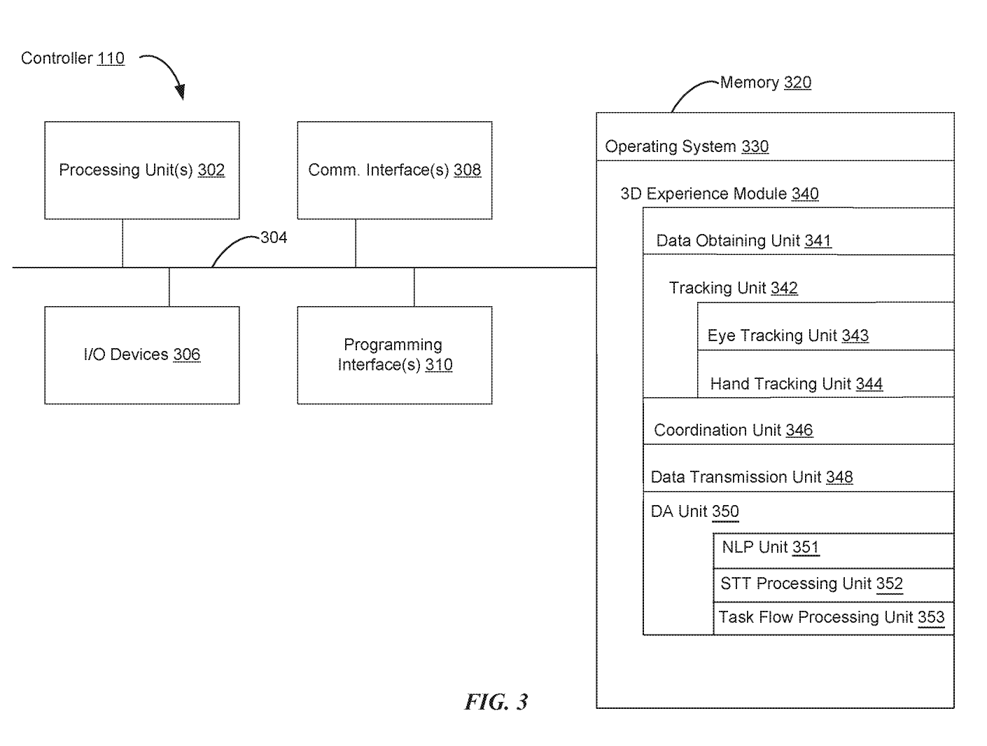

Returning to FIG. 1, controller 110 is configured to manage and coordinate a user’s experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3, 4, 5A-5G, and 6 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and 3D sound unit 360.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user’s gaze (or more broadly, the user’s eyes, face, or head) using data obtained from eye tracking device 130. In some examples, eye tracking unit 343 tracks the position and movement of the user’s gaze relative to a physical environment, relative to the user (e.g., the user’s hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user’s eyes. The eye tracking cameras may be pointed towards the user’s eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user’s eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user’s hands and/or motions of one or more portions of the user’s hands. Hand tracking unit 344 tracks the position and/or motion relative to scene 105, relative to the user (e.g., the user’s head, face, or eyes), relative to a device worn or held by the user, relative to content displayed by user-facing component 120, and/or relative to a coordinate system defined relative to the user’s hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user’s body through the air including motion of the user’s body relative to an absolute reference (e.g., an angle of the user’s arm relative to the ground or a distance of the user’s hand relative to the ground), relative to another portion of the user’s body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user’s body (e.g., a tap gesture that includes movement of a hand in a predetermined pose by a predetermined amount and/or speed, or a shake gesture that includes a predetermined speed or amount of rotation of a portion of the user’s body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user’s hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene, either proactively or upon request from the user. In some examples, DA unit 350 performs at least some of: converting speech input into text (e.g., using speech-to-text (STT) processing unit 352); identifying a user’s intent expressed in a natural language input received from the user; actively eliciting and obtaining information needed to fully satisfy the user’s intent (e.g., by disambiguating terms in the natural language input and/or by obtaining information from data obtaining unit 341); determining a task flow for fulfilling the identified intent; and executing the task flow to fulfill the identified intent.

In some examples, DA unit 350 includes natural language processing (NLP) unit 351 configured to identify the user intent. NLP unit 351 takes the n-best candidate text representation(s) (word sequence(s) or token sequence(s)) generated by STT processing unit 352 and attempts to associate each of the candidate text representations with one or more user intents recognized by the DA. In some examples, a user intent represents a task that can be performed by the DA and has an associated task flow implemented in task flow processing unit 353. The associated task flow is a series of programmed actions and steps that the DA takes in order to perform the task. The scope of a DA’s capabilities is, in some examples, dependent on the number and variety of task flows that are implemented in task flow processing unit 353, or in other words, on the number and variety of user intents the DA recognizes.

In some examples, once NLP unit 351 identifies a user intent based on the user request, NLP unit 351 causes task flow processing unit 353 to perform the actions required to satisfy the user request. For example, task flow processing unit 353 executes the task flow corresponding to the identified user intent to perform a task to satisfy the user request. In some examples, performing the task includes causing computer system 101 to provide output (e.g., graphical, audio, and/or haptic output) indicating the performed task.

DA unit 350 is configured to perform tasks based on user-selected objects in a three-dimensional scene. Specifically, in conjunction with data obtaining unit 341 and tracking unit 342, DA unit 350 is configured to perform a task based on detected input such as gaze input and/or gesture input (e.g., touching an object, pointing at an object, picking up an object, gesturing towards an object, nodding at an object, tapping on an object, and/or pressing a button related to the object) that selects an object (e.g., a physical object and/or a virtual object). In some examples, selection is indicated because the user input is in the direction of the object, the user input is on the object, and/or the user input otherwise indicates user interest in an object. Examples of the task include providing information about the object, identifying the object, and/or performing another action based on the object (e.g., enabling and/or disabling a similar and/or related object and/or adding an object to a list).

In some examples, DA unit 350 generates and/or provides an output based on the selected object and the task (e.g., an action) for the selected object when DA unit 350 determines that the task for the selected object meets a confidence criterion (e.g., DA unit 350 is confident that the user is trying to invoke a particular task based on the selected object, the context of the object and/or the computer system, and/or other factors related to the task and/or the object).

In some examples, DA unit 350 selects an action from a plurality of available actions for the selected object in response to detecting the user input and/or in accordance with a determination that an action for the selected object meets the confidence criterion. In some examples, DA unit 350 selects a highest ranked action from the plurality of actions, wherein the ranking is based on how confident DA unit 350 is that a user would request that particular action.

In some examples, the plurality of available actions are determined based on previous interactions between a user a digital assistant (e.g., DA unit 350). In some examples, the plurality of available actions are determined based on context information detected by the computer system. In some examples, the plurality of available actions are determined based on a property of the selected object.

In some examples, DA unit 350 performs the task for the selected object by determining a query for the selected object and then determining a response to the query for the selected object. For example, when an object is unfamiliar or new to DA unit 350, DA unit 350 may determine that a query the user would provide is “what is that?” and determine an answer to the query automatically upon detection a user input selecting the object. In some examples, the query is previously provided by the user when interacting with DA unit 350 and a different object. In some examples, the query is not provided by the user (e.g., is a default and/or preloaded query).

In some examples, the query is determined based on context information related to the selected object and/or the computer system. For example, when the context indicates that the location of the computer system is somewhere the computer system has not previously visited, DA unit 350 is more likely to select queries such as “what is this?” and “where is this located?.” As another example, when the context indicates that the location of the computer system is somewhere familiar (e.g., the user’s home) then DA unit 350 is more likely to select a query such as “do I need more of this?” In some examples, the query is determined based on a property of the object. For example, when the object has a property that can be enabled or disabled, DA unit 350 is more likely to select a query related to that functionality such as “how do I turn this on?”

In some examples, DA unit 350 generates and/or provides an output including a request for a task (e.g., an action) to be performed related to the selected object when DA unit 350 determines that the action for the selected object does not meet the confidence criterion (e.g., DA unit 350 is not confident that the user is trying to invoke the particular task based on the selected object and other factors and instead requests clarification from the user about which action to perform). In some examples, the request includes a list of possible actions. In some examples, the request includes a question for a user to answer. In some examples, the request includes selectable options. In some examples, DA unit 350 detects (e.g., receives) a user input indicative of a provided possible action and in response to detecting the user input, performs the possible action.

In some examples, when DA unit 350 determines that the action for the selected object does not meet the confidence criterion, DA unit 350 provides a default response such as “I can provide information or perform an action for the selected object, would you like more details about this?” In some examples, when DA unit 350 determines that a predetermined time has passed after providing the request for a task to be performed, DA unit 350 provides the default response and/or causes the default response to provided.

In some examples, DA unit 350 selects actions from a plurality of possible actions to include in the request for a task to be performed. In some examples, the plurality of possible actions are determined based on previous interactions between a user a digital assistant (e.g., DA unit 350). In some examples, the plurality of possible actions are determined based on context information detected by the computer system. In some examples, the plurality of possible actions are determined based on a property of the selected object. In some examples, actions from the plurality of possible actions are selected when DA unit 350 determines that a possible action has a confidence score above a threshold (e.g., 50%, 75%, 85%, etc.), indicating that DA unit 350 is confident the user has at least some interest in that possible action.

The aforementioned functionalities of DA unit 350 are discussed in greater detail below with respect to FIGS. 5A-5G.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350 are implemented using the AI model(s). For example, DA unit 350 implements one or more AI models to perform speech recognition, intent determination (e.g., natural language processing and/or image processing), object recognition, and/or response generation.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination (e.g., natural language processing), sentiment analysis, computer vision tasks (e.g., object recognition and scene understanding), question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLaMA, LLaMA-2, and LLaMA-3 from Meta Platforms, Inc.

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding’s relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-5G illustrate a device performing tasks based on user-selected objects that are present in a three-dimensional scene, according to some examples.

Device 500 implements at least some of the components of computer system 101. For example, device 500 includes one or more sensors configured to detect data (e.g., image data and/or audio data) corresponding to the respective scenes. In some examples, device 500 is an HMD (e.g., an XR headset or smart glasses) and FIGS. 5A-5G illustrate the user’s view of the respective scenes via the HMD. For example, FIGS. 5A-5G illustrate physical scenes viewed via pass-through video, physical scenes viewed via direct optical see-through, or virtual scenes viewed via one or more displays of the HMD. In other examples, device 500 is another type of device, such as a smart watch, a smart phone, a tablet device, a laptop computer, a pair of display-less glasses, headphones, earbuds, or a projection-based device.

The examples of FIGS. 5A-5G illustrate that the user and device 500 are present within the respective scenes. For example, the scenes are physical or extended reality scenes and the user and device 500 are physically present within the scenes. In other examples, an avatar of the user is present within the scenes. For example, when the scenes are virtual reality scenes, the avatar of the user is present within the virtual reality scenes.

In FIG. 5A, device 500 detects user input 502a of a gesture that is touching object 504a and thus, is indicating selection of object 504a that is presented on display generation component 510 of device 500. In response to detecting user input 502a selecting object 504a, device 500 determines (e.g., with DA unit 350 as discussed above with reference to FIG. 3) whether an action for selected object 504a meets a confidence criterion.

In particular, device 500 determines that the action of providing information about object 504a based on a query such as “what is this?” meets the confidence criterion and thus, device 500 (e.g., DA unit 350) is confident that the user is requesting further information about object 504a. In some examples, device 500 determines the action of asking a query and/or providing information based on previous interactions between the user and device 500 and/or a digital assistant of device 500 in which as user has asked similar questions for similar objects. In some examples, device 500 determines the action of asking a query and/or providing information based on contextual information related to object 504a and/or device 500, such as that object 504a is the only object located in the room and thus the user is likely to be interested in further details about the object.

After determining that the action of providing information about object 504a based on a query such as “what is this?” meets the confidence criterion, device 500 (e.g., DA unit 350) determines the response that object 504a is a red ball and provides output 506a including this information that is determined as a response to the query. In this way, device 500 provides relevant information to the user based on a single input (e.g., input 502a) selecting object 504a without requiring the user to provide other inputs or clarifications.

At FIG. 5B, device 500 detects user input 502b of a gesture that is touching object 504a and thus, is indicating selection of object 504a that is presented on display generation component 510 of device 500. In response to detecting user input 502a selecting object 504a, device 500 determines (e.g., with DA unit 350 as discussed above with reference to FIG. 3) whether an action for selected object 504a meets a confidence criterion.

In particular, device 500 determines that an action does not meet the confidence criterion and thus, device 500 (e.g., DA unit 350) requires more information about which actions should be performed. Accordingly, device 500 provides output 506b requesting “what action would you like to perform?” so that the user can provide the action and/or task that they would like to perform on object 504a.

After providing output 506b, device 500 receives user input 508c of “what is this?” as shown in FIG. 5C. Based on user input 508c, device 500 determines that the user is requesting further information about object 504a and thus the action is to provide information to the user. Accordingly, device 500 determines that object 504a is a red ball and provides output 506c of “this is a red ball” to the user in response to user input 508c specifying the action to be performed.

In FIG. 5D, device 500 detects user input 502d of a gesture that is pointing at object 504d and thus, is indicating selection of object 504d that is presented on display generation component 510 of device 500. In response to detecting user input 502d selecting object 504d, device 500 determines (e.g., with DA unit 350 as discussed above with reference to FIG. 3) whether an action for selected object 504d meets a confidence criterion.

In particular, device 500 determines that the action of enabling object 504d (a smart light bulb) by changing the state of object 504d from “off” to “on” meets the confidence criterion and thus, device 500 (e.g., DA unit 350) is confident that the user is requesting to enable object 504d. In some examples, device 500 determines the action of enabling the object based on previous interactions between the user and device 500 and/or a digital assistant of device 500 in which as user has enabled similar objects and/or objects with similar properties and/or capabilities. In some examples, device 500 determines the action of enabling the object based on contextual information related to object 504d and/or device 500, such as that the room is currently dark and light from smart bulb 504d would help the user see.

After determining that the action of enabling object 504d meets the confidence criterion, device 500 (e.g., DA unit 350) determines the response that object 504d has been enabled and provides output 506d including this information. In this way, device 500 performs a task with object 504d based on a single input (e.g., input 502d) selecting object 504d without requiring the user to provide other inputs or clarifications.

At FIG. 5E, device 500 detects user input 502e of a gesture pointing at object 504e and thus, is indicating selection of object 504e that is presented on display generation component 510 of device 500. In response to detecting user input 502e selecting object 504e, device 500 determines (e.g., with DA unit 350 as discussed above with reference to FIG. 3) whether an action for selected object 504e meets a confidence criterion. In some examples, user input 502e is the press of a button and/or a gesture in the direction of a button representing object 504e. Thus, while in some examples input 502e is a gesture on or towards object 504e, in other examples, input 502e is a gesture on or towards a button, virtual object, affordance, and/or other user interface element representing object 504e.

Device 500 determines that an action does not meet the confidence criterion and thus, device 500 (e.g., DA unit 350) requires more information about which action should be performed. Accordingly, device 500 provides default output 506e of “I can perform an action for this type of object, please provide a potential action” to inform the user that actions can be performed and request further information from the user in the form of an action and/or task that they would like to perform on object 504e.

At FIG. 5F, device 500 detects user input 502f of a gesture pointing at object 504f and thus, is indicating selection of object 504f that is presented on display generation component 510 of device 500. In response to detecting user input 502f selecting object 504f, device 500 determines (e.g., with DA unit 350 as discussed above with reference to FIG. 3) whether an action for selected object 504f meets a confidence criterion. In some examples, user input 502f is the press of a button and/or a gesture in the direction of a button representing object 504f. Thus, while in some examples input 502f is a gesture on or towards object 504f, in other examples, input 502f is a gesture on or towards a button, virtual object, affordance, and/or other user interface element representing object 504f.

Device 500 determines that an action does not meet the confidence criterion and thus, device 500 (e.g., DA unit 350) requires more information about which action should be performed. Accordingly, device 500 provides output 506f including the possible actions of providing information about object 504f or adding item 504f to the user’s shopping list. As discussed above, these possible actions are selected from a plurality of possible action for object 504f and are selected based on a number of factors such as the properties of object 504f, the context of object 504f, previous interactions between the user and the digital assistant, and/or other information related to object 504f.

After providing output 506f, device 500 receives user input 508g of “add this to my shopping list” as shown in FIG. 5G. Based on user input 508g, device 500 determines that the requested action is to add the light bulb to the user’s shopping list and thus performs the requested task by adding object 504f to the user’s shopping list. Accordingly, device 500 provides output 506g of “smart light bulb added to your shopping list” to the user in response to user input 508g.

Additional descriptions regarding FIGS. 5A-5G are provided below in reference to method 600 described below with respect to FIG. 6.

FIG. 6 is a flow diagram of a method 600 for performing tasks based on user-selected objects that are present in a three-dimensional scene, according to some examples. In some examples, method 600 is performed at a computer system (e.g., computer system 101 in FIG. 1 and/or device 500) that is in communication with one or more image sensors (e.g., a camera and/or a photo sensor. In some examples, the one or more image sensors are a part of the computer system (e.g., are at least partially inside of the computer system and/or are directly connected to the computer system). In some examples, the one or more image sensors are a part of another computer system. In some examples, at least one image sensor is a part of the computer system. In some examples, at least one image sensor is a part of another computer system. In some examples, at least one image sensor is a forward-facing camera of the computer system (e.g., the camera faces a front of the computer system). In some examples, at least one image sensor is a backward facing camera of the computer system (e.g., the camera faces the back of the computer system).) and a display generation component (e.g., a screen, a touch sensitive display, a projector, and/or another component with the capabilities of displaying an image and/or video). In some examples, method 600 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 600 are distributed across multiple computer systems, e.g., a computer system and a separate server system. Some operations in method 600 are, optionally, combined, the orders of some operations are, optionally, changed, and some operations are, optionally, omitted.

At block 602, a user input (e.g., 502a, 502b, 502d, 502e, and/or 502f) (e.g., touching, pointing at, picking up, gesturing towards, nodding at, tapping, and/or pressing a button) indicating selection of an object (e.g., 504a, 504d, 504e, and/or 504f) displayed with the display generation component (e.g., 510) is detected (e.g., received or captured).

At block 606, in response to (604) detecting the user input indicating selection of the object, a first output (e.g., 506a and/or 506d) based on the selected object and the action for the selected object is provided in accordance with a determination (e.g., by DA unit 350) that an action (e.g., asking a query and/or performing a task) for the selected object meets a confidence criterion.

At block 608, in response to (604) detecting the user input indicating selection of the object, a second output (e.g., 506b, 506e, and/or 506f) including a request for an action to be performed is provided in accordance with a determination (e.g., by DA unit 350) that the action (e.g., asking a query and/or performing a task) for the selected object does not meet the confidence criterion.

In some examples, the user input indicating the selection of the object displayed with the display generation component includes a user touch on the object.

In some examples, the user input indicating the selection of the object displayed with the display generation component includes a press on a button indicating the object.

In some examples, the action for the selected object includes: determining a query for the selected object; and determining a response to the query for the selected object, wherein the first output includes the response to the query for the selected object. In some examples, the query is not provided by a user. In some examples, the query is determined based on context information detected by the computer system. In some examples, the query is determined based on a previous interaction between a user and a digital assistant. In some examples, the query is determined based on a property of the object displayed with the display generation component.

In some examples, the first output includes information about the object. In some examples, the first output includes a result of a task performed as part of the action for the selected object.

In some examples the computer system is in communication with a display generation component and the object is displayed with the display generation component.

In some examples, method 600 further includes: in accordance with the determination that the action for the selected object meets the confidence criterion and prior to providing the first output based on the selected object and the action for the selected object, selecting the action from a plurality of available actions for the selected object. In some examples, the plurality of available actions are determined based on previous interactions between a user and a digital assistant. In some examples, the plurality of available actions are determined based on context information detected by the computer system. In some examples, the plurality of available actions are determined based on a property of the selected object.

In some examples, the request for the action to be performed includes at least two possible actions. In some examples, method 600 further includes in accordance with a determination that a possible action has a confidence score above a threshold, selecting the possible action as one of the at least two possible actions. In some examples, method 600 further includes after providing the second output including the request for the action to be performed: detecting a user input selecting a first possible action of the at least two possible actions; and in response to detecting the user input selecting the first possible action of the at least two possible actions: performing the first possible action; and providing a third output including a response based on the first possible action. In some examples, method 600 further includes after providing the second output including the request for the action to be performed and in accordance with a determination that the user inputs has not been detected within a predetermined amount of time, providing a default response.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to output spoken responses to assist a user. Further, other uses for personal information data that benefit the user are also contemplated by the present disclosure. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of outputting spoken responses for the user, the present technology can be configured to allow users to select to “opt in” or “opt out” of participation in the collection of personal information data during registration for services or anytime thereafter. In another example, users can select not to provide personal information data based on which on spoken responses are generated. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, spoken responses can be generated based on non-personal information data or a bare minimum amount of personal information, such as the content being requested by the device associated with a user, other non-personal information available to the service, or publicly available information.

What is claimed is:

1. A computer system configured to communicate with one or more image sensors, the one or more computer systems comprising:
one or more processors; and
one or more memories storing one or more programs configured to be executed by the one or more processors, the one or more programs including instructions for:
detecting a user input indicating selection of an object;
in response to detecting the user input indicating selection of the object:
in accordance with a determination that an action for the selected object meets a confidence criterion, providing a first output based on the selected object and the action for the selected object; and
in accordance with a determination that the action for the selected object does not meet the confidence criterion, providing a second output including a request for an action to be performed.

2. The computer system of claim 1, wherein the user input indicating the selection of the object includes a user touch on the object.

3. The computer system of claim 1, wherein the user input indicating the selection of the object includes a press on a button indicating the object.

4. The computer system of claim 1, wherein the action for the selected object includes:
determining a query for the selected object; and
determining a response to the query for the selected object, wherein the first output includes the response to the query for the selected object.

5. The computer system of claim 4, wherein the query is not provided by a user.

6. The computer system of claim 4, wherein the query is determined based on context information detected by the computer system.

7. The computer system of claim 4, wherein the query is determined based on a previous interaction between a user and a digital assistant.

8. The computer system of claim 4, wherein the query is determined based on a property of the object.

9. The computer system of claim 1, wherein the first output includes information about the object.

10. The computer system of claim 1, wherein the first output includes a result of a task performed as part of the action for the selected object.

11. The computer system of claim 1, the one or more programs further including instructions for:
in accordance with the determination that the action for the selected object does not meet the confidence criterion, providing a default response.

12. The computer system of claim 1, the one or more programs further including instructions for:
in accordance with the determination that the action for the selected object meets the confidence criterion and prior to providing the first output based on the selected object and the action for the selected object, selecting the action from a plurality of available actions for the selected object.

13. The computer system of claim 12, wherein the plurality of available actions are determined based on previous interactions between a user and a digital assistant.

14. The computer system of claim 12, wherein the plurality of available actions are determined based on context information detected by the computer system.

15. The computer system of claim 12, wherein the plurality of available actions are determined based on a property of the selected object.

16. The computer system of claim 1, wherein the request for the action to be performed includes at least two possible actions.

17. The computer system of claim 16, the one or more programs further including instructions for:
in accordance with a determination that a possible action has a confidence score above a threshold, selecting the possible action as one of the at least two possible actions.

18. The computer system of claim 16, the one or more programs further including instructions for:
after providing the second output including the request for the action to be performed:
detecting a user input selecting a first possible action of the at least two possible actions; and
in response to detecting the user input selecting the first possible action of the at least two possible actions:
performing the first possible action; and
providing a third output including a response based on the first possible action.

19. The computer system of claim 18, the one or more programs further including instructions for:
after providing the second output including the request for the action to be performed and in accordance with a determination that the user inputs has not been detected within a predetermined amount of time, providing a default response.

20. A non-transitory computer-readable storage medium storing one or more programs configured to be executed by one or more processors of a computer system that is in communication with one or more image sensors, the one or more programs including instructions for:
detecting a user input indicating selection of an object;
in response to detecting the user input indicating selection of the object:
in accordance with a determination that an action for the selected object meets a confidence criterion, providing a first output based on the selected object and the action for the selected object; and
in accordance with a determination that the action for the selected object does not meet the confidence criterion, providing a second output including a request for an action to be performed.

21. A method, comprising:
at a computer system in communication with one or more image sensors:
detecting a user input indicating selection of an object;
in response to detecting the user input indicating selection of the object:
in accordance with a determination that an action for the selected object meets a confidence criterion, providing a first output based on the selected object and the action for the selected object; and
in accordance with a determination that the action for the selected object does not meet the confidence criterion, providing a second output including a request for an action to be performed.
